(19) United States
(12) Patent Application Publication
(10) Pub. No.: US 2024/0060231 A1
(43) Pub. Date: Feb. 22, 2024

(54) COMPOSITION AND METHOD FOR MICROBIAL CONTROL ON MATERIAL SURFACES

(71) Applicant: Microban Products Company, Huntersville, NC (US)

(72) Inventors: Burke Irving NELSON, Mooresville, NC (US); Gina Parise Sloan, Statesville, NC (US); James Marion Rapley, Huntersville, NC (US); Mai Ha, Comelius, NC (US)

(21) Appl. No.: 18/385,666

(22) Filed: Oct. 31, 2023

Related U.S. Application Data
(62) Division of application No. 17/128,894, filed on Dec. 21, 2020.
(60) Provisional application No. 62/955,161, filed on Dec. 30, 2019.
(60) Provisional application No. 62/955,155, filed on Dec. 30, 2019.

(51) Int. Cl. D06M 13/184; D06M 11/76; D06M 16/00; D06M 11/36; C09D 7/63; A01N 25/10; A01N 37/04; A01N 37/10; C08J 3/22; C08K 5/092; C09D 127/08

(52) U.S. Cl. CPC D06M 13/1845; D06M 11/76; D06M 16/00; D06M 11/36; C09D 7/63; A01N 25/10; A01N 37/04; A01N 37/10; C08J 3/226; C08K 5/092; C09D 127/08; D06M 2400/00; D06M 2200/00; C08J 2327/08

(57) ABSTRACT

A composition and method for microbial control on a material surface using a minimum risk pesticide such as a GRAS antimicrobial/preservative component. The GRAS antimicrobial/preservative component is preferably an organic acid.

### CROSS-REFERENCE TO RELATED APPLICATIONS

This application claims priority from U.S. Non-Provisional application Ser. No. 17/128,894, filed on Dec. 21, 2020, which claims priority from U.S. Provisional Patent Application No. 62/955,161, filed on Dec. 30, 2019, and U.S. Provisional Patent Application No. 62/955,155, filed on Dec. 30, 2019, in the United States Patent and Trademark Office. The disclosures of which are incorporated herein by reference in their entireties.

### FIELD OF THE INVENTION

The invention relates to a composition and method for microbial control on a material surface, more particularly to a composition and method for microbial control on a material surface using a minimum risk pesticide.

### BACKGROUND OF THE INVENTION

Microbial control on material surfaces can be achieved through the incorporation of antimicrobials into a base material. Current practice relies heavily on the use of metal containing actives such as silver, zinc and/or copper. The presence of “heavy metals” in products that may eventually leach into the environment either during use or after disposal of a treated product have become an issue of concern for environmental policy and regulators and others that strive to influence consumer markets.

Alternatively, the use of organic molecules, such as phenolics and azoles, can be leveraged to treat material surfaces through incorporation. These chemistries can be temperature limited, sensitive to UV degradation and are expensive to use when the entire mass of an object is to be treated. In addition, many have dangerous toxicity profiles and can cause undesirable side effects that can affect the aesthetics of a treated article.

Thus, there is a need for alternative chemistries for microbial control on material surfaces that are cost-effective and have good efficacy but are also safe.

### SUMMARY OF THE INVENTION

The present invention relates to a composition and method for microbial control on a material surface using a minimum risk pesticide.

In an embodiment of the invention, a composition for microbial control on a material surface is provided. The composition exhibits an antimicrobial property. The composition comprises a polymeric material, and a Generally-Recognized-as-Safe (GRAS) additive or component having an antimicrobial or preservative property. Examples of GRAS additives include, but are not limited to, a minimum risk pesticide, a food preservative, among others.

In an embodiment of the invention, the GRAS antimicrobial/preservative component is an organic acid.

In an embodiment of the invention, the organic acid is selected from the group consisting of benzoic acid, sorbic acid, citric acid, and a combination thereof.

In an embodiment of the invention, the GRAS antimicrobial/preservative component is a food preservative.

In an embodiment of the invention, a method for microbial control on a material surface is provided. The method comprises incorporating a GRAS antimicrobial/preservative component into a polymeric material.

Advantages of direct incorporation include increased durability compared with coating technologies, as well as the elimination of the coating process step during product manufacture.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a Thermogravimetric analysis (TGA) plot at 10° C./min showing weight loss of GRAS salts up to 275° C.; little volatization was seen.

FIG. 2 is a TGA Plot at 10° C./min showing weight loss of GRAS acids up to 275° C.; considerable volatization occurred.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

The present invention relates to a composition and method for microbial control on a material surface.

In an embodiment of the invention, a composition that is “Generally Recognized As Safe” (GRAS) for imparting microbial control on a material surface is provided. The acronym “GRAS” is used by federal regulatory agencies to refer to substances that are considered to be “Generally Recognized As Safe” when used in accordance with good manufacturing practices. They are often used as food additives. For example, such regulations include 21 CFR 182, 21 CFR 184, and 21 CFR 186.

Examples of GRAS components or compounds include, but are not limited to, food preservatives. Food preservatives are suitable for use in the composition of the present invention as they are classified as minimum risk pesticides yet provide antimicrobial efficacy. Furthermore, a food preservative suitable for use in the present invention to has antimicrobial efficacy with a low skin toxicity profile and the ability withstand industrial polymer processing requirements, typically at temperatures of approximately >200° C. and miscibility with molten polymers. Food preservatives that volatilize or degrade at temperatures lower than 200° C. may be suitable but require unique engineering considerations to reduce their thermal exposure during processing.

In an embodiment of the present invention, the food preservative is an organic acid. Examples of organic acids include, but are not limited to, benzoic acid, propionic acid, sorbic acid, citric acid, lactic acid, ascorbic acid, acetic acid, erythorbic acid, fumaric acid, malic acid, glycolic acid, derivatives thereof and a combination thereof. Preferred organic acids include, but are not limited to, benzoic acid, sorbic acid, citric acid, and a combination thereof.

The composition of the present invention may comprise one or more additives. For example, an essential oil can be added in combination with benzoic acid, sorbic acid, or a combination thereof to have stronger activity against fungal species. Some essential oils, such as cinnamon oil, have little to no antibacterial activity but have a unique impact on fungal species.

Examples of essential oils include, but are not limited to, cedarwood oil, tea tree oil (Melaleuca alternifolia), eucalyptus oil (Eucalyptus globulus or E. radiata), clove oil (Eugenia caryophyllata), oregano oil (Origanum vulgare), thyme oil (Thymus vulgaris), geranium oil (Pelargonium graveolens), cinnamon bark oil (Cinnamomum zeylanicum), peppermint oil (Mentha piperita), lemongrass oil (Cymbopogon flexuosus), basil oil (Ocimum basilicum), lavender oil (Lavandula angustifolia), lemon oil (Citrus limon), rosemary oil (Salvia rosmarinus), bergamot oil (Citrus bergamia), perilla oil (Perilla frutescens), coriander oil (Coriandrum sativum), citron oil (Citrus medica), and a combination thereof. Preferred essential oils include, but are not limited to, cinnamon bark oil (Cinnamomum zeylanicum), lemongrass oil (Cymbopogon flexuosus), thyme oil (Thymus vulgaris), cedarwood oil, citronella, peppermint oil, rosemary oil, clove oil, and a combination thereof.

Additionally, it may be desirable to control non-microbial related odors. The organic acids (or combinations thereof) can provide the ability to neutralize alkaline based odors such as ammonia by their acidic nature. Acids with aryl groups like benzoic acid have the potential to sequester ring based odorants, such as pyridine. To supplement these effects, an additional odor mitigation compound can be added to the combination of the organic acids, and/or essential oils for the removal of existing odors. The addition of an odor mitigation compound results in a unique blend that can provide antimicrobial and odor control benefits. Examples of odor mitigation compounds include, but are not limited to, metal oxides, activated carbon, sodium bicarbonate, calcium carbonate, and zinc rincoleate.

The addition of a metal oxide (for example, ZnO) to any of the chemistries results in a unique blend that can provide antimicrobial and odor control benefits.

In an embodiment of the invention, the composition of the present invention, preferably in a form of a polymeric concentrate such as a masterbatch or a polymeric binding for coatings, comprises benzoic acid, sorbic acid, or a combination thereof. In a polymeric concentrate, an active concentration of 1% to 60%, or more preferably 5% to 40%, by weight of the composition is needed. In a polymeric binder for use in durable coatings, a concentration ranging from 0.1% to 40% based on solution % solids is needed. If more than one acid is used in combination, then the total weight of the active acids is between 5% to 40% by weight of the final composition.

The composition of the present invention may optionally comprise an essential oil at a concentration of 1% to 50%, or more preferably 5% to 20% by weight of the total composition and may optionally comprise an odor mitigation compound at a concentration of 1% to 60%, or more preferably 5% to 40%, by weight of the total composition.

The carrier for the masterbatch is preferably a low melt polymer or copolymer compatible with the base materials into which the masterbatch is to be incorporated. It is desirable to minimize any high heat history of the thermally sensitive acid actives. The carrier will offer protection during high-temperature processing to allow incorporation into higher temperature polymers such as polypropylene (PP). Examples of base polymeric materials include, but are not limited to, PP, EMA, polyolefins, SAN, TPU, ABS, PS, and PC and PVC. Polypropylene (PP), for example, is a polyolefin polymer commonly used to make many consumer items. This concentrate is then pellet-to-pellet blended with a base raw material (such as PP) and injection molded to form parts that are of 0.05% to 10% active concentration (by weight of the final article). The essential oils are preferably at a final concentration of 0.05% to 5.0% and odor mitigation compounds at a similar concentration range to the acids such as 0.05% to 10%. The use as a masterbatch carrier of ethylene methacrylate (EMA), propylene-ethylene copolymers (such as Vistamaxx™), SEBS, PE, and PP are examples of the concept of using a low melt polymer to encapsulate the raw, thermally sensitive additives such as these GRAS acids without damaging or volatizing them, and then using the concentrate to treat polymers that must be processed at temperatures higher than would otherwise be possible.

The use of direct incorporation of these acids for antimicrobial protection rather than using the typical coating process is an important improvement as it eliminates a costly coating step and further improves product quality; incorporated antimicrobials are more durable and cannot be worn off or abraded away. In the case of polymers, when the organic acids are incompatible with the base resin, a stabilizer or compatibilizer can be added to the masterbatch to increase the shelf life stability of the product.

In embodiments where coating is desired, the polymeric binder may consist of or essentially consist of acrylic, acrylate, urethane, isocyanate, polyvinylidene chloride (PVDC), polyvinylidene fluoride (PVDF), hexafluoropropylene, carboxymethyl cellulose (CMC), polyvinyl alcohol (PVA), polyvinyl acetate (PVAc), polyamide, and polyimide. These may be added in any combination with any suitable oligomer, homopolymer, copolymer or elastomer. In some embodiments, the binder may be aqueous, non-aqueous, or contain trace amounts of cosolvent. The type of polymeric binder is not particularly limited and may include any polymer whose composition may be suitable for coating. The GRAS is added to form coatings that are 0.05% to 10% concentration by weight of final coating. A non-limiting example may be a PVDC polymeric binder aqueous coating with 0.5% active concentration of benzoic acid. Once incorporated, the GRAS acids become bound to the substrate.

Applications include, but are not limited to, treatment of polymer materials to generate an antimicrobial and/or odor benefit on the surface of said materials.

Unlike present technologies that are being classified as possible toxins, the composition of the present invention is non-hazardous, applicable to most forms of polymer manufacturing, stable to polymer processing shear and heat and does not significantly impact the final product properties. Table A below shows tensile, flexural and impact measurements for PP change little when benzoic acid is incorporated at different levels with different polymer concentrate carriers.

TABLE A
Table A - Physical testing results of injection molded PP
parts treated with GBA between 0.2% and 0.35%, using two
different polymer carriers for masterbatch concentrate

| | | Flex - ASTM D | | Tensile - | | Impact - | |
|---|---|---|---|---|---|---|---|
| | | 790, Proc A | | ASTM D638 | | ASTM D 256 | |
| | % GBA | Modu- | Peak | Modu- | Yield | Energy | Impact |
| Level of | & | lus | Stress | lus | Stress | Abs. | Res. |
| GBA | Carrier | kpsi | kpsi | kpsi | kpsi | mJ | J/m |
| 0 | Control | 204 | 6.5 | 366 | 5.11 | 97 | 23 |
| 0.2% | 10% in | 240 | 7.29 | 320 | 5.34 | 120 | 30 |
| | EMA | | | | | | |
| 0.35% | 10% in | 249 | 7.42 | 330 | 5.34 | 110 | 27 |
| | EMA | | | | | | |
| 0.35% | 20% in | 253 | 7.59 | 308 | 5.48 | 117 | 29 |
| | EMA | | | | | | |
| 0.35% | 10% in | 251 | 7.45 | 340 | 5.43 | 100 | 24 |
| | PE | | | | | | |

### Example 1

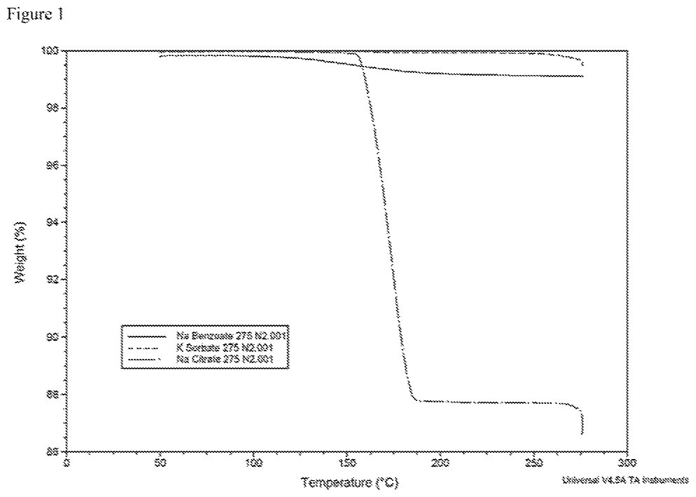

Initial work focused on three GRAS chemistries, the salts of benzoic acid, sorbic acid, and citric acid. FIG. 1 shows a TGA plot of these salts that indicates all salts are thermally stable to temperatures greater than 300° C.

In FIG. 1, the TGA Plot at 10° C./min showed volatization of GRAS salts up to 275° C. The sorbate and citrate salts were stable (did not lose any mass) to temperatures greater than 275° C., while the citrate was approximately 10% water which is why it lost approximately 10% weight then leveled out—the salt itself did not volatize. This thermal stability and reported antimicrobial efficacy made these compounds seemingly ideal for this application.

Each salt chemistry was evaluated by compounding into a polyolefin carrier at 10% concentrate level, then using that polymer concentrate as a masterbatch to injection mold PP plaques at various end-use levels for testing. Commodity PP and EMA materials in a twin-screw extruder for compounding, and in a 35-Ton injection molding machine were used to make test plaques.

This served the dual purpose of testing processing compatibility as well as providing samples to test active efficacy levels.

TABLE 1
Table 1 - Results of TR19031210, testing of GRAS salts
in PP. Log reduction >1 required to pass ISO 22196.

| | ISO 22196 | ISO 22196 | TM90 | TM90 |
|---|---|---|---|---|
| Sample | Ec | Sa | Kp | Sa |
| PP w/0.25% GNC | .3 | NR | NZ | NZ |
| PP w/0.5% GNC | .4 | NR | NZ | NZ |
| PP w/0.5% GKS | NR | NR | NZ | NZ |
| PP w/1.0% GKS | .2 | NR | NZ | NZ |
| PP w/0.5% GNC & | NR | NR | NZ | NZ |
| 1.0% GKS combo | | | | |
| PP w/0.5% GNB | 1.0 | NR | NZ | NZ |
| PP w/1.0% GNB | .4 | NR | NZ | NZ |

NR = no reduction. NZ = No zone. Both indicate a failure.
GNC = sodium citrate,
GKS = potassium sorbate,
GNB = sodium benzoate

Unexpectedly, the salts alone (sodium benzoate, potassium sorbate, and trisodium citrate) of each acid above resulted in no significant bacterial efficacy per the ISO 22196 test at any active concentration up to 1% as shown in Table 1 despite heat stability as indicated in FIG. 1. Nor did the samples demonstrate any efficacy using zone of inhibition testing (AATCC TM90). Additionally, the use of the salts to treat the plaques resulted in the plaques becoming opaque due to the high levels in use.

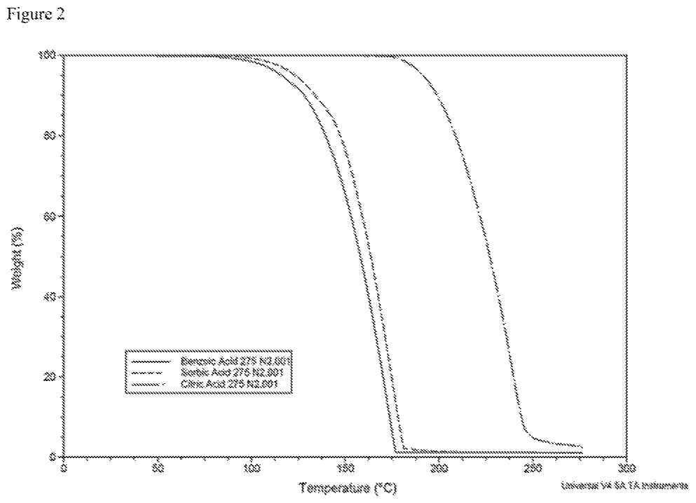

Secondly, the acid moieties (benzoic acid, sorbic acid, and citric acid) were investigated despite that they did not appear to have sufficient thermal stability to survive PP processing as examined in FIG. 2. Citric acid started to volatize at 200° C. Benzoic and sorbic acids started volatizing at approximately 100° C. and were essentially entirely gone by the time the TGA test sample reached 200° C., suggesting they would be unsuitable for direct processing into PP. Rather than compound directly into PP to make a PP masterbatch concentrate, a polymer with a lower processing temperature range was selected. EMA is compatible with PP and has a very wide processing temperature range. It can be compounded at temperatures as low as 120° C. and can withstand processing temperature in excess of 250° C. The three acids above were successfully compounded into EMA at 10% concentrations to make masterbatch concentrates with negligible losses due to volatization.

Notwithstanding the TGA thermal properties, three EMA/acid masterbatches were compounded into PP at higher temperatures than 200° C. and surprisingly, analysis indicated very little loss of the acid actives during processing. The prior encapsulation of the acid in the EMA prevented the active ingredient loss through volatization in spite of the processing temperature and made production of PP parts possible. Compounding the acids into a compatible low-melt carrier to minimize the volatization loss of the GRAS acids during processing was found to be a critical part of the incorporation process.

Test plaques were made by injection molding into PP at 0.5% and 1% active level concentrations, all samples showed little aesthetic impact from the acid additives. All samples generated showed good antibacterial efficacy except citric acid (GCA), which was good at the higher level but fell off at the lower level (Table 2). Further experiments indicated efficacy as low as 1000 ppm for sorbic acids (GSA) and for benzoic acids (GBA) 2000 ppm to 3500 ppm was considered a robust letdown into PP.

TABLE 2

| | ISO 22196 | ISO 22196 | | |
|---|---|---|---|---|
| Sample | Ec | Sa | TM90 Kp | TM90 Sa |
| PP w/0.5% GCA | NR | 1.9 | NZ | NZ |
| PP w/1.0% GCA | 3.4 | 3.0 | NZ | NZ |
| PP w/0.5% GBA | 4.3 | 3.0 | NZ | NZ |
| PP w/1.0% GBA | 4.5 | 3.0 | NZ | NZ |
| PP w/0.5% GSA | 4.0 | 3.0 | NZ | NZ |
| PP w/1.0% GSA | 4.5 | 3.0 | NZ | NZ |

Table 2 shows Log reduction results of TR19031105, testing of GRAS acids in PP plaques. Log reduction >1 required to show a significant difference in bacterial populations. NZ=No zone, indicates a failure for the TM90. GCA=citric acid, GBA=benzoic acid, GSA=sorbic acid. The acids did not leach so the TM90 was not suitable to determine efficacy, but all except the lowest GCA sample passed the ISO 22196. The plaques were tested in the Xenon Arc and QUV instruments to ensure good UV stability—it was found that the samples changed only slightly in color, a much better response than the deep yellow color shift generated by zinc pyrithione treated samples, or the brown color shift generated by silver treated samples.

In addition to processing at 200° C., samples were run with PP at 250° C. to simulate the use of these GRAS acids in polymers that process at higher temperatures than polypropylene. Samples were also run using extended residence times in the injection molding machine (from the normal 30 second residence time to 120 seconds residence time) to simulate a process with a longer cycle time that would hold the polymer material at temperature for an extended period of time—the extended cycle were run at both 200° C. and 240° C. The samples produced from these runs also displayed excellent efficacy and very little aesthetic change (a slight darkening at higher temperatures).

TABLE 3

| | ISO 22196 | ISO 22196 |
|---|---|---|
| SAMPLE | Ec | Sa |
| PP w/0.25% GBA (120 s residence, 240° C.) | 3.7 | 2.6 |
| PP w/0.5% GBA (120 s residence, 240° C.) | 4.6 | 3.2 |
| PP w/0.25% GSA (120 s residence, 240° C.) | 4.0 | 3.2 |
| PP w/0.5% GSA (120 s residence, 240° C.) | 4.3 | 3.2 |

Table 3 shows the log reductions generated by samples held for an extended residence time of 2 minutes at 240° C. in the injection molder, demonstrating heat stability in a production relevant environment.

TABLE 4
Log Reduction of PE and EVA samples with 0.1% GBA

| Sample | ISO 22196 Ec | ISO22196 Sa |
|---|---|---|
| PE with 0.1% GBA | >3 | >1 |
| EVA with 0.1% GBA | >3 | >1 |

TABLE 5
Efficacy of GBA treated PE and EVA against yeast
Candida albicans (Ca) and fungus Aspergillus
niger (An) using the ASTM E2180 protocol

| Sample | ASTM E2180 Ca | ASTM E2180 An |
|---|---|---|
| PE with 0.3% GBA | >2 | >2 |
| EVA with 0.1% GBA | n/a | >1 |

Testing the benzoic and sorbic acid treated material against fungus using qualitative methods did not show any difference between untreated and treated. It is well known that most plastics do not support fungal growth and common industrial qualitative standards such as AATCC TM30 (part 3) or ASTM G21 are not sensitive enough to demonstrate efficacy. Even untreated PP or PE materials often have no observable fungal growth after the test. However, the quantitative fungal method of the ASTM E2180 protocol is more sensitive and demonstrates that incorporation of a GRAS organic acid such as benzoic acid into a material will provide over 99% (2 log) reductions in fungal growth for PE and over 90% reduction when incorporated into EVA. The addition of essential oils to benzoic or sorbic acid will further increase the antifungal efficacy of the treated materials.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method for microbial control on a material surface, the method comprising:
incorporating a GRAS additive or component having an antimicrobial or preservative property into a polymeric material.

2. The method according to claim 1, wherein the GRAS antimicrobial/preservative component is an organic acid.

3. The method according to claim 2, wherein the organic acid is selected from the group consisting of benzoic acid, propionic acid, sorbic acid, citric acid, lactic acid, ascorbic acid, acetic acid, erythorbic acid, fumaric acid, malic acid, glycolic acid, a derivative thereof, and a combination thereof.

4. The method according to claim 3, wherein the organic acid is selected from the group consisting of benzoic acid, sorbic acid, citric acid, and a combination thereof.

5. The method according to claim 1, further comprising incorporating an essential oil with the GRAS additive or component having an antimicrobial or preservative property.

6. The method according to claim 5, wherein the essential oil is selected from the group consisting of cedarwood oil, tea tree oil (Melaleuca alternifolia), eucalyptus oil (Eucalyptus globulus or E. radiata), clove oil (Eugenia caryophyllata), oregano oil (Origanum vulgare), thyme oil (Thymus vulgaris), geranium oil (Pelargonium graveolens), cinnamon bark oil (Cinnamomum zeylanicum), peppermint oil (Mentha piperita), lemongrass oil (Cymbopogon flexuosus), basil oil (Ocimum basilicum), lavender oil (Lavandula angustifolia), lemon oil (Citrus limon), rosemary oil (Salvia rosmarinus), bergamot oil (Citrus bergamia), perilla oil (Perilla frutescens), coriander oil (Coriandrum sativum), citron oil (Citrus medica), and a combination thereof.

7. The method according to claim 1, wherein the GRAS additive or component is added in a form of a masterbatch.

8. The method according to claim 8, wherein the masterbatch has a low melt polymer or copolymer as a carrier.

9. The method according to claim 9, wherein the carrier is compatible with the polymeric material.

10. The method according to claim 1, wherein the polymeric material is selected from the group consisting of PP, EMA, polyolefins, SAN, TPU, ABS, PS, and PC and PVC, and a combination thereof.

11. The method according to claim 1, further comprising forming an article with the polymeric material having the GRAS additive or component incorporated therein.

12. The method according to claim 11, wherein the GRAS additive or component having an antimicrobial or preservative property is present in a range of 0.05% to 10% active concentration by weight of the article.

13. The method according to claim 8, wherein an essential oil is present in a range of 0.05% to 5.0% active concentration by weight of the article.

14. The method according to claim 1, further comprising an odor mitigation compound.

15. The method according to claim 14 wherein an odor mitigation compound is present in a range of 0.05% to 10% active concentration by weight of the article.

16. The method according to claim 1, further comprising forming a coating with the polymeric material having the GRAS additive or component incorporated therein.

17. The method according to claim 16, wherein the GRAS additive or component having an antimicrobial or preservative property is present in a range of 0.05% to 10% concentration by weight of the coating.

18. The method according to claim 16, wherein the coating is a PVDC polymeric binder aqueous coating with 0.5% active concentration of benzoic acid.
